(19) United States
(12) Patent Application Publication
(10) Pub. No.: US 2007/0071091 A1
(43) Pub. Date: Mar. 29, 2007

(54) Audio and video compression for wireless data stream transmission

(76) Inventors: Juh-Huei Lay, Tao-Yuan Shien (TW); Chih-Ta Star Sung, Glonn (DE); Yin-Chun Blue Lan, Wurih Township (TW); Wei-Ting Jwo, Taichung (TW)

Correspondence Address: Chih-Ta Star Sung;BLD. 52, RM. 308, NO. 195, CHU TUNG TOWNSHIP, CHUNG HSING RD., SEC. 4, HSINCHU COUNTY, 310, TW

(21) Appl. No.: 11/234,812

(22) Filed: Sep. 26, 2005

(51) Int. Cl. H04N 11/04; H04N 11/02

(52) U.S. Cl. 375/240.2; 375/240.21

(57) ABSTRACT

A video compression, transmission and decoding procedure includes: reducing the image data by calculating the average of a predetermined number of pixels, calculating the DCT coefficients and dividing DCT coefficients by predetermined matrix of values, and applying fixed length of code to represent the DCT coefficients. Low frequency DCT coefficients of each block of pixels are saved in a temporary storage device, should the data loss or damage happened during transmission, the low frequency DCT coefficients of the corresponding block are decoded to represent the lost data. In audio compression and transmission point, a group of audio samples are separated to be at least two sub-groups of audio samples, should any audio sample is lost or damaged, the interpolated value of the nearest adjacent samples of at least one sub-group is used to represent the lost or damaged audio sample.

### BACKGROUND OF THE INVENTION

1. Field of Invention

The present invention relates to audio and video compression techniques, and particularly relates to the audio and video compression and decompression method specifically for wireless data stream transmission and results in good noise immunity and less impact when data damage happened during transmission.

2. Description of Related Art

In the past decades, the semiconductor migration trend has driven wireless communication technology to be more convenient with less expensive and wider bandwidth which coupled with sharp quality of LCD display have driven the digital audio and video wireless communication to be more attractive.

Wireless communication technology including Wireless LAN (802.11x), Blue Tooth, DECT, RF have made audio and video data transmission and receiving through air feasible. The audio and video data stream can be transmitted through air to the destination under communication protocols. The audio or video player with wireless receiver has convenience in handless and good mobility. Wireless audio and video communication also plays more and more critical role in future digital home, portable media devices and video mobile phone.

Due to the limitation of available bandwidth of the wireless communication protocols, the audio and video data, especially the later have to be compressed before transmit to the destination and being decompressed by a receiving end in the destination. The technique of compression reduces the data rate of audio and video. The prior art wireless audio and video communication systems just transmits audio and video data stream to the destination by using most likely video compression technology like MPEG or motion JPEG as shown in FIG. 1. It is not uncommon that data got lost or damaged during wireless transmission. Due to the lack of efficient error correction in wireless communication, the MPEG and motion JPEG are inefficient in wireless video communication and easily cause much error and propagated from one frame to other frames in MPEG.

This invention takes new alternative and more efficiently and easily overcomes the data loss or data damage risk in wireless communication. Even data loss or damage happen, it quickly recovers the lost or damaged data to a high degree of similarity.

### SUMMARY OF THE INVENTION

The present invention of the audio and video compression for wireless transmission specifically designed for wireless data stream transmission and has good noise immunity which can also recovered quickly and accurately from data loss and data damage.
The present invention of the audio and video compression for wireless transmission divide the audio data stream into smaller groups of audio samples and compress the data separately.
According to an embodiment of this invention of the audio and video compression for wireless transmission, the nth samples of a predetermined length are grouped together as an independent compression unit.
According to an embodiment of this invention of the audio compression, when an audio sample is lost (or damaged) during transmission, the adjacent samples, previous and next samples, are decoded and used to represent the lost (damaged) sample.
According to an embodiment of this invention of the audio compression, the differential values of adjacent audio samples are re-ordered according to the magnitude of a neighboring group of samples.
According to another embodiment of this invention of the video compression, the orthogonal pixels of a frame is put together to form two independent sub-frame of pixels and to be compressed and transmit separately.
According to an embodiment of this invention of the video compression for wireless transmission, when some pixel within a certain block in a specific frame is lost (or damaged) during transmission, the pixels of the closest decompressed block of previous sub-frame are decoded and used to represent the lost (damaged) pixels of that block.
According to an embodiment of this invention of the video compression for wireless transmission, when pixels distributed in more multiple blocks in a specific frame is lost (or damaged) during transmission, the closest blocks pixels of the previous sub-frame and the next sub-frame are decoded and used to represent the lost (damaged) pixels of that block.
According to an embodiment of this invention, when pixels distributed in a specific block in a specific frame is lost (or damaged) during transmission, the corresponding block pixels of DC coefficient of the previous nearest sub-frame is used to represent the lost (damaged) pixels of that block.
According to an embodiment of this invention of the video compression, the raw image is down sampled by a predetermined factor and block by block transformed to DCT coefficients and quantized by some predetermined parameters for each of the DCT coefficient.
According to an embodiment of this invention of the video compression, the quantized DCT coefficients are coded by fixed length coding method with each sub-band DCT coefficient having predetermined fixed length of code.
According to an embodiment of this invention of the video compression, the amount of DCT coefficients needed to be coded by the fixed length coding method depends on the variance of each block pixels.

Other aspects and advantages of the present invention will become apparent from the following detailed description, taken in conjunction with the accompanying drawings, illustrating by way of example the principles of the invention. It is to be understood that both the foregoing general description and the following detailed description are by examples, and are intended to provide further explanation of the invention as claimed.

### BRIEF DESCRIPTION OF THE DRAWINGS

FIG. 1 depicts a prior art wireless audio-video transmission system.

FIG. 2A depicts a prior art video compression method, a motion JPEG video compression procedure.

FIG. 2B depicts a prior art video compression method, an MPEG video compression standard.

FIG. 3 illustrates method of this invention of audio compression separating the odd samples and even samples into individual group for compression and for wireless transmission and the way it recovers the lost (damaged) audio sample.

FIG. 4 illustrates method of this invention of audio compression with multiple groups of separate samples.

FIG. 5 illustrates method of this invention of audio decompression with multiple groups of separated samples.

FIG. 6 shows a method of this invention of video compression by dividing an image into two sub-frames (odd sub-frame and even sub-frame) with each collecting from the orthogonal pixels.

FIG. 7A illustrates the procedure of recovering a block of pixels with data loss or damage.

FIG. 7B illustrates the procedure of recovering a lost or damaged block of pixels in a motion compensation mode.

FIG. 8 illustrates the procedure of this invention of the video compression algorithm.

FIG. 9 illustrates the procedure of this invention of the video decompression algorithm with and without data loss.

### DESCRIPTION OF THE PREFERRED EMBODIMENTS

The popularity of wireless communication devices and protocols including Wireless LAN (802.11x), Blue Tooth, DECT, RF have made audio and video stream data transmission through the air possible. The wireless data transmission has played critical role in audio communication, and video communication will follow in the next decade.

Due to the limitation of bandwidth and huge amount of audio and video stream data to be traveling in the air, the data loss or data damage rate during wireless transmission is high. Some wireless communication protocols have defined the mechanisms of handling the data loss or data damage. Most of them include the CRC checking which is to check the data to determine whether the data amount is right or wrong. When data is wrong, some mechanisms might be enabled to correct the lost or damaged data including “request of re-send” or “Error Correction Coding” algorithms. No matter whether the correction or re-sending mechanism, as data loss or damage happened, the correction mechanism takes long delay time to recover or correct.

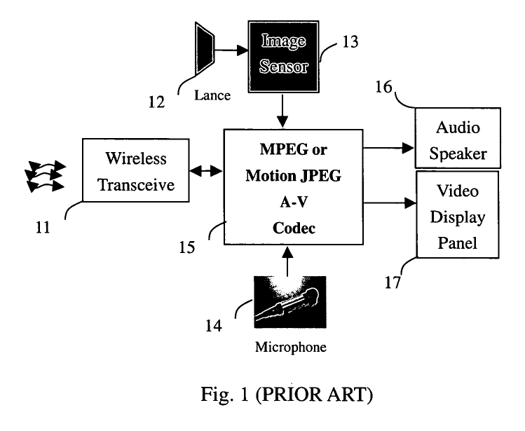

Due to the huge amount of audio and video raw data to be traveling in the air during wireless transmission, in some applications, the video and audio data are compressed before being transmitted to the destination which has a receiver with decompression engine to recover the compressed audio and video data streams. In prior approaches of wireless audio and video stream transmission, as shown in FIG. 1, the MPEG and motion JPEG 15 are commonly used solutions. An image is input through a lance 12 and being captured by an image sensor array 13 before going through the compression procedure. The audio inputting from a microphone 14 is compress ed by an audio compression codec 15 which might use the same engine like MPEG or motion JPEG. The compressed audio and video stream data is then packed and send to the destination through the wireless transceiver 11. In reserve data flow direction, the compressed audio and video receiving from the wireless transceiver 11 will be sent to the audio and video codec 15 for recovering before being displayed onto the video display panel 17 and to the audio speaker 16. The MPEG is a motion video compression standard set by ISO which uses previous or/and next frame as referencing frames to code the pixel information of the present frame, any error of video stream will be propagated to the next frames of image and degrades the quality gradually. The motion JPEG has less impact of data loss or data damage since the block of image is coded independent on other frame. Nevertheless, the JPEG is a widely accepted international image compression standard, hence, most engines are designed following the standard bit stream format, therefore, any data loss or damage cause fatal error in decoding the rest of the block pixels within an image.
Drawback of the prior art wireless audio and video system with MPEG or motion JPEG compression algorithms includes the possible loss of the stream data with no mechanism of correction and the data rate will be higher if error correction code is included in the stream. Another side effect of the prior art video playback system is that an MPEG picture uses previous frame of image as reference, any error in a frame of pixels can be propagated to the next following frames of pictures and causes more and more distortion in further frames. JPEG picture is coded by intra-coded mode which does not rely on other frame than itself.

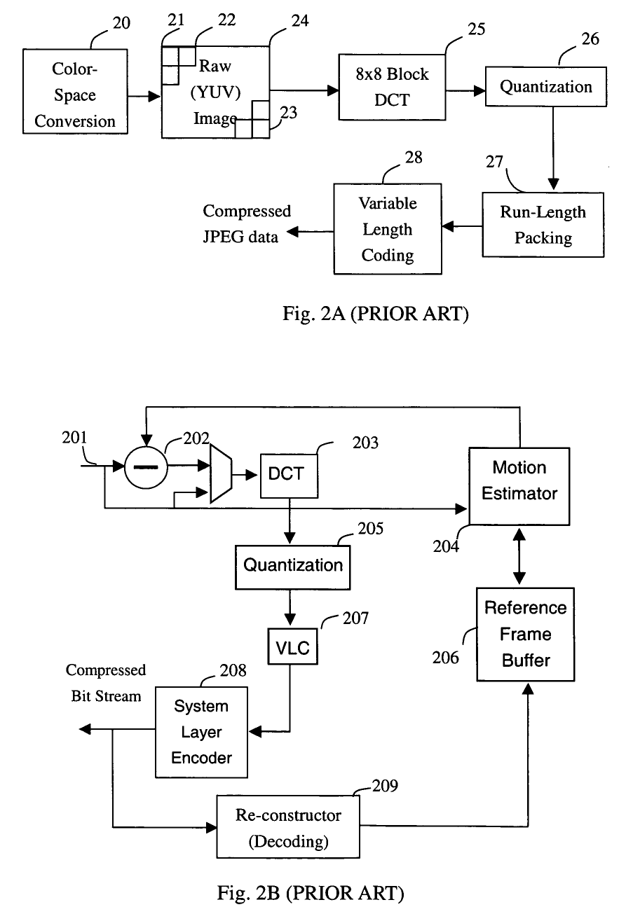

JPEG image compression as shown in FIG. 2A includes some procedures in image compression. The color space conversion 20 is to separate the luminance (brightness) from chrominance (color) and to take advantage of human being's vision less sensitive to chrominance than to luminance and the can reduce more chrominance element without being noticed . An image 24 is partitioned into many units of so named “Block” of 8×8 pixels to run the JPEG compression. A color space conversion 10 mechanism transfers each 8×8 block pixels of the R(Red), G(Green), B(Blue) components into Y(Luminance), U(Chrominance), V(Chrominance) and further shifts them to Y, Cb and Cr. JPEG compresses 8×8 block of Y, Cb, Cr 21, 22, 23 by the following procedures:
Step 1: Discrete Cosine Transform (DCT)
Step 2: Quantization
Step 3: Zig-Zag scanning
Step 4: Run-Length pair packing and
Step 5: Variable length coding (VLC).

DCT 25 converts the time domain pixel values into frequency domain. After transform, the DCT “Coefficients” with a total of 64 subbabd of frequency represent the block image data, no longer represent single pixel. The 8×8 DCT coefficients form the 2-dimention array with lower frequency accumulated in the left top corner, the farer away from the left top, the higher frequency will be. Further on, the more closer to the left top, the more DC frequency which dominates the more information. The more right bottom coefficient represents the higher frequency which less important in dominance of the information. Like filtering, quantization 26 of the DCT coefficient is to divide the 8×8 DCT coefficients and to round to predetermined values. Most commonly used quantization table will have larger steps for right bottom DCT coefficients and smaller steps for coefficients in more left top corner. Quantization is the only step in JPEG compression causing data loss. The larger the quantizationj step, the higher the compression and the more distortion the image will be.

After quantization, most DCT coefficient in the right bottom direction will be rounded to “0s” and only a few in the left top corner are still left non-zero which allows another step of said “Zig-Zag” scanning and Run-Length packing 27 which starts left top DC coefficient and following the zig-zag direction of scanning higher frequency coefficients. The Run-Length pair means the number of “Runs of continuous 0s”, and value of the following non-zero coefficient.

The Run-Length pair is sent to the so called “Variable Length Coding” 28 (VLC) which is an entropy coding method. The entropy coding is a statistical coding which uses shorter bits to represent more frequent happen patter and longer code to represent the less frequent happened pattern. The JPEG standard accepts “Huffman” coding algorithm as the entropy coding. VLC is a step of lossless compression.

The JPEG compression procedures are reversible, which means the following the backward procedures, one can decompresses and recovers the JPEG image back to raw and uncompressed YUV (or further on RGB) pixels.

FIG. 2B illustrates the block diagram and data flow of a prior art MPEG digital video compression procedure, which is commonly adopted by compression standards and system vendors. This prior art MPEG video encoding module includes several key functional blocks: The predictor 202, DCT 203, the Discrete Cosine Transform, quantizer 205, VLC encoder 207, Variable Length encoding, motion estimator 204, reference frame buffer 206 and the re-constructor (decoding) 209. The MPEG video compression specifies I-frame, P-frame and B-frame encoding. MPEG also allows macro-block as a compression unit to determine which type of the three encoding means for the target macro-block. In the case of I-frame or I-type macro block encoding, the MUX selects the coming pixels 201 to go to the DCT 203 block, the Discrete Cosine Transform, the module converts the time domain data into frequency domain coefficient. A quantization step 205 filters out some AC coefficients farer from the DC corner which do not dominate much of the information. The quantized DCT coefficients are packed as pairs of “Run-Level” code, which patterns will be counted and be assigned code with variable length by the VLC Encoder 207. The assignment of the variable length encoding depends on the probability of pattern occurrence. The compressed I-type or P-type bit stream will then be reconstructed by the re-constructor 209, the reverse route of compression, and will be temporarily stored in a reference frame buffer 206 for future frames' reference in the procedure of motion estimation and motion compensation. As one can see that any bit error in MPEG stream header information will cause fatal error in decoding and that tiny error in data stream will be propagated to following frames and damage the quality significantly.

In prior art audio compression, MP3, AAC are popular audio compression algorithms both transfer the time domain (or names Wave domain) audio data into frequency domain and filter out some information before a VLC coding. Both MP3 and AAC audio compression have the following disadvantages which prevent them to be commonly used in the wireless applications. 1^{st}, the MP3 and AAC use a large amount of audio samples as a compression unit, for example, 1024 samples. This makes long delay time, said about 25 mili-second, before an encoder can start compressing. From decoding point of view, the decoder has to wait long time to receive a pack of the compressed data stream before it starts decompressing the audio data. 2^{nd} any bit error of the compressed bit stream in wireless transmission, the error will be distributed to all samples in wave domain audio data and severely degrade the audio quality.

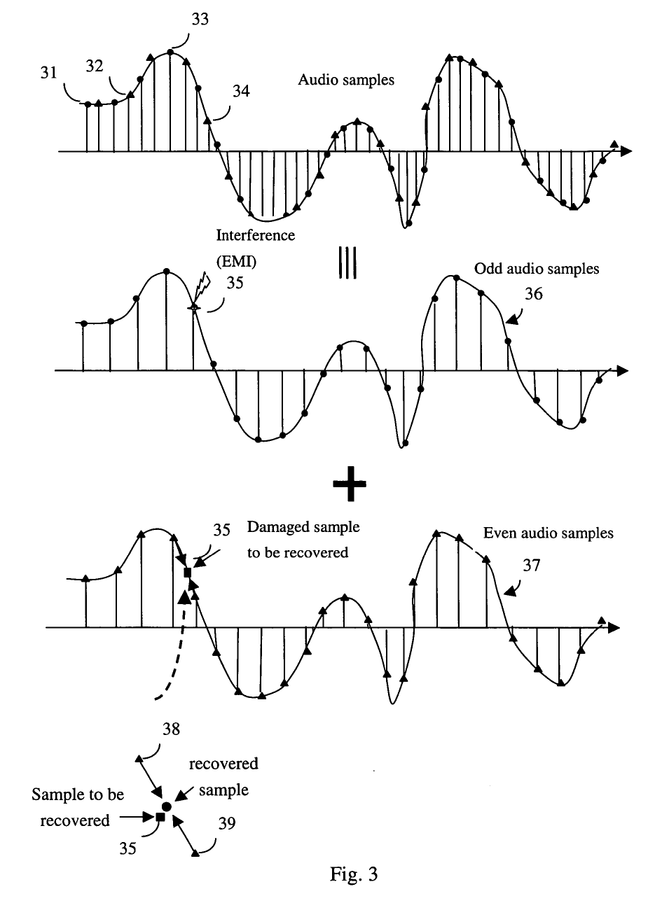

To overcome the drawback of the wireless transmitting the audio data stream, this invention separates a group of audio samples into sub-groups of audio samples and compresses these sub-groups independently before transmitting. FIG. 3 shows the procedure of this invention of the audio compression mechanism and an alternative of data recovering for the lost or damaged data. This is an example of dividing the audio samples 31, 32, 33, 34 into two separate sub-groups of audio samples, the odd samples 36 and the even samples 37. Any damage happened to the audio sample 35 by EMI or any other interference within one sub-group, the adjacent audio samples 38, 39 are decompressed and used to interpolate and recover the lost or damaged audio sample which will be most likely having value very close to the lost/damaged audio sample. The above procedure of audio compression and recovering the lost or damaged audio samples will be applied to the situation of multiple data loss within a pack of audio stream and the adjacent audio samples are used to recover the lost/damaged audio stream data. For accelerating the speed of recovering the lost data when a certain amount of audio samples within a pack data stream are lost or damaged, the nearest sub-group of the audio data samples can be applied to substitute the lost/damaged pack of audio stream.

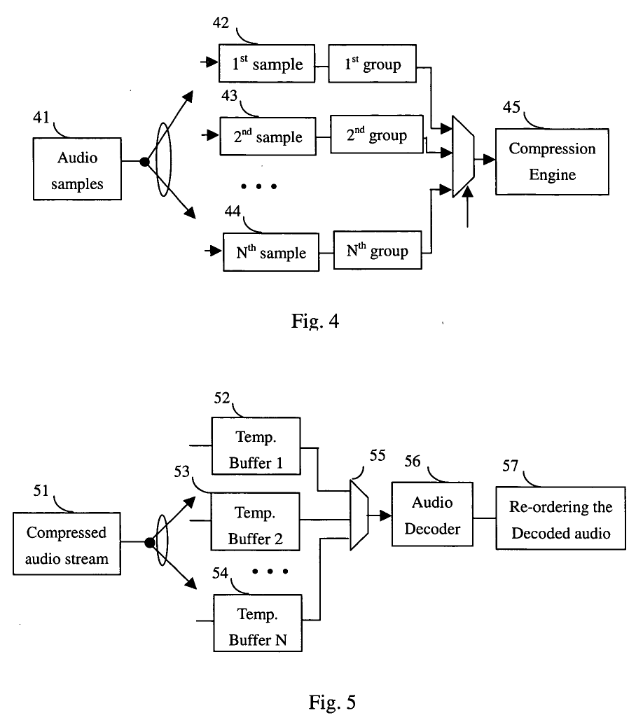

FIG. 4 illustrates the procedure of this invention of the audio compression. An audio pack of stream samples 41 are separated into N sub-groups of samples 42, 43, 44 with each sub-group being fed periodically by the source audio samples. The compression engine 45 periodically selects the input of sub-group of audio stream and compresses the audio stream independently. There will be several of bits of data, so names as the “marker” being inserted into the stream data of each sub-group of audio. FIG. 5 shows the procedure of the audio decompression of this invention. The compressed audio stream 51 is separated into sub-groups of audio stream by detecting the marker bits and periodically distributing the data of compressed sub-group audio stream into temporary buffer 52, 53, 54 for decompression. The periodically selected compressed audio data stream are sent to the audio decoder 56 and the decompressed streams of each sub-group are re-ordered 57 and put together to form the decompressed audio data.

Since the wireless transmission has high potential of hitting high air traffic jam, a controller which periodically detects the air traffic condition before transmitting the compressed audio stream, will inform the audio compression engine about the air traffic condition. Should the air traffic is busy and the compressed audio stream is not available to be transmitted, the audio compression engine will reduce the pack length of the existing and further pack of audio samples by half till the traffic jam is lessened. The minimum length of each pack of sub-group of audio samples is predetermined by detecting the traffic condition where the system is located. And the minimum number can be adjusted over time. When air traffic gets better, the pack length is doubled every time when it transmitted a last pack of compressed audio samples.

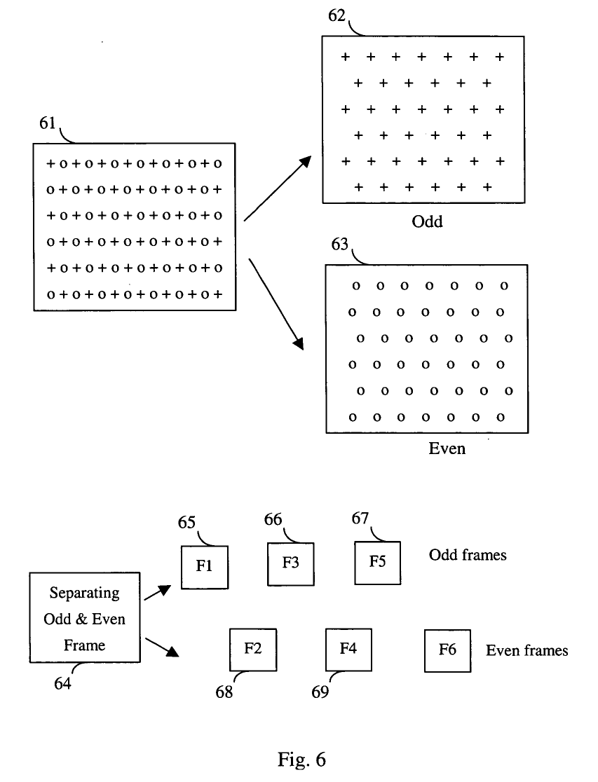

FIG. 6 illustrates the basic concept of the present invention of the video compression for wireless. An image frame 61 is separated to be two independent sub-frames with the orthogonal pixels of a frame putting together to form two independent sub-frames 62, 63 and to be compressed and transmit separately. In a sequence of video frames, a frame of image is separated into two sub-frames before compression. After compression, the compressed video streams are sent by interleaving mode of having odd frames 65, 66, 67 and even frames 68, 69. Since spatially, the adjacent pixels of odd and even image are very close, having high correlation and similarity is expected. If a large amount of pixel data loss or damage happened, a whole sub-frame of the nearest sub-frame is used to replace the whole sub-frame which has a large amount of pixels lost/damaged.

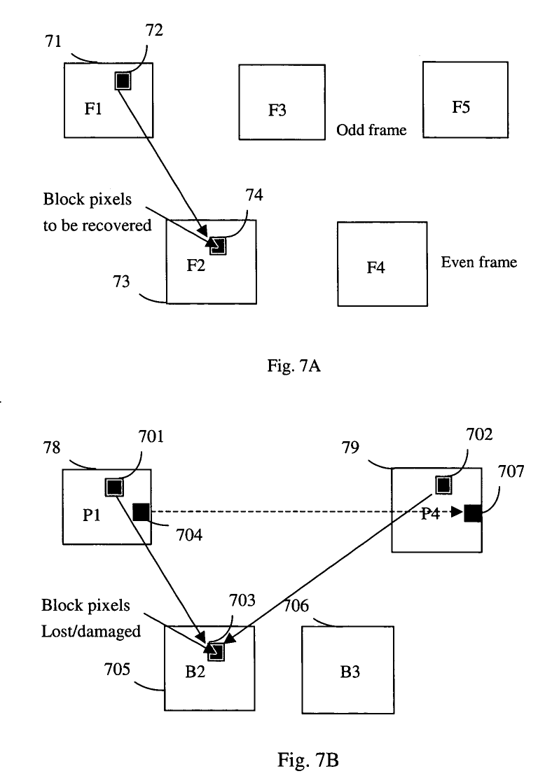

In the case of a small amount of blocks data loss happened, the pixel data of the corresponding location of previous frame or sub-frame are retrieved to replace the lost or damaged pixels as shown in FIG. 7 No matter whether a frame is divided into 2 sub-frames or not FIG. 7A illustrates the procedure of recovering the lost image block of pixels. When data loss or damage happened within a block of pixels 72 of a video frame 71, the corresponding block 74 of pixels of the nearest frame 73 (or sub-frame if the frame is divided into 2 frames) are used to represent the lost block of pixels. In another mode of motion compensated video compression with B-frames 705, 706(a bidirectional frame like that in MPEG) and P-frames 78, 79, when a block of pixels 707 is lost or data damaged within a P-frame, the corresponding block 701 of the closest P-frame is used to replace the lost block 707. Should the data loss of a block pixels 703 happened in a B-frame 705, the corresponding block of pixels 701, 702 of the nearest two P-frames 78, 79 are interpolated to replace the lost or damaged block 703, of pixels within a B-frame 75.

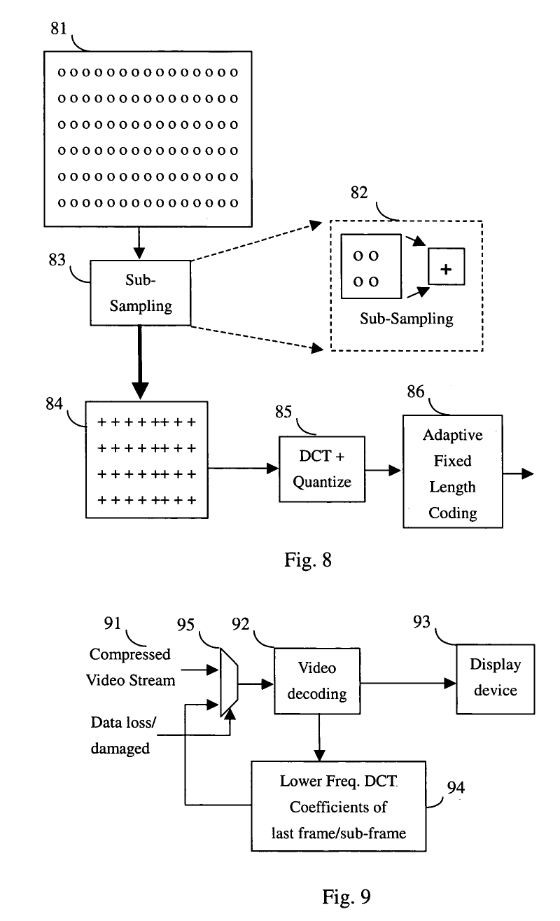

FIG. 8 depicts the compression procedure of this invention of the video compression. A frame 81 of image goes through a sub-sampling procedure 83, the 1^{st} step to reduce the data rate to be a smaller frame 84 of image before it goes through the compression steps including the DCT & quantization 85 and a fixed length coding 86. The sub-sampling process takes the average 82 (marked “+” of 4 pixels marked “o” ) of 2 in X-axis and 2 in Y-axis. In the DCT transform, a 4×4 pixels are used as a compression unit, depending on the variance range of a block pixels and quantization steps of each DCT coefficient, this invention of DCT transform calculates only a certain amount of non-zero coefficients. The DCT coefficients will then be coded by a fixed length coding method with a predetermined length of each frequency band. For instance, the AC1 and AC2 are coded by 5 bits length, AC3, AC4 and AC5 are coded by 4 bits, AC6, AC7, AC8 and AC9 are coded by 3 bits, others are rounded to be all “0s” with a assigned shortest code to represent no-more-non-zero. A block of pixels with wide range of image tone might have more non-zero DCT coefficients and wider variance which will require longer bits to represent and to keep good quality. From another hand, a block of pixels with little variance will have less non-zero DCT coefficients and narrower variance which will require less bits to represent and be coded by shorter code.

A best match algorithm is applied to this invention of the video codec for wireless video transmission, the target block of pixels of the current frame is compared to the neighboring pixels of the nearest frame of pixels. A searching range with nearly the same distance of the block size in both X-axis and Y-axis of the block is predetermined for best match block searching. A threshold of SAD, Sum of Absolute Difference is preset to early stop the searching when the value is reached, the block with that location will be identified as the best matching block. For example, in the QCIF (176×144 pixels), a searching range on-chip SRAM of +/−4 pixels of X-axis and +/−4 pixels if Y-axis, a total of nine 4×4 blocks distance of pixels (9×4×4=144 pixels) of the nearest frame are saved to be compared to the target block of current frame. When a best matching condition is not match within the searching range of pixels, the block will be coded by an intra-frame type coding method. An intra-frame coding does not use other frame pixels as reference.

In the receiver and video decoding point, the wireless receiver gets the compressed video stream 91 and sends it to the video decoder 92 for decompressing the video stream. During recovering the video data, the decoder sends the lower frequency DCT coefficients of a frame of image into a temporary storage device 94. Should the data loss or damage happened during wireless transmission, the block of pixels of the corresponding location in previous frame with lower frequency DCT coefficients are copied to represent the lost/damaged block of pixels and fed into the decoder through an MUX 95. The decoded video images will then be sent to the display device 93.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method of compressing digital video, comprising:
down sampling the first raw image into another shape of the second image with smaller amount of pixels compared to the raw image;
block by block discrete cosine transforming and calculating the predetermined amount of DCT coefficients for each block of image; and
adaptively applying fixed length of code to represent each of the sub-band AC coefficient.

2. The method of claim 1, wherein the average value of pixels of at least one in X-axis and at least one in Y-axis are calculated to represent the value of the down sampled pixel;

3. The method of claim 1, wherein a block of N×M pixels are transformed by the DCT algorithm to form the N×M DCT coefficients with lower frequency DCT coefficients being placed in the left-top corner and higher frequency DCT coefficients in the right-bottom corner.

4. The method of claim 1, wherein a matrix of N×M numbers are predetermined to divide each of the DCT coefficients of the N×M block of pixels.

5. The method of claim 1, wherein the variance of a block pixel values determines the length of coding for each sub-band DCT coefficient.

6. The method of claim 5, wherein the larger variance of a block pixel values, the longer fixed coded will be used to represent the DCT coefficients and the smaller variance of a block pixel values, the shorter fixed coded will be assigned to represent the DCT coefficients.

7. The method of claim 1, wherein the code length of each sub-band DCT coefficient varies dependent on the frequency with longer code for lower frequency sub-band DCT coefficient and shorter code for higher frequency sub-band DCT coefficient.

8. A method of compressing and decompressing the video data stream, for wireless data transmission, comprising:
separating a frame of image into a first sub-frame image and a second sub-frame image with each pixel of the first sub-frame image and the second sub-frame image interleaved;
compressing and transmitting each of the first sub-frame frame and the second sub-frame frame of image separately;
receiving the compressed image, decoding it and storing at least one low frequency DCT coefficient of each block of a previous frame into a temporary storage buffer; and
when data damage or data loss happened in any block within an image, the temporarily stored low frequency DCT coefficients of the corresponding location of the nearest frame or a frame or a sub-frame image are decoded to represent the lost or damaged image data.

9. The method of claim 8, wherein the low frequency DCT coefficients include at least the DC coefficient.

10. The method of claim 8, wherein DC coefficient is encoded by a predictive mode of the difference between adjacent blocks.

11. The method of claim 8, wherein the low frequency DCT coefficients are classified into a several of sub-bands with each sub-band having at least two DCT coefficients.

12. The method of claim 8, wherein the difference of a block pixels are compared to the nearest frame for the best matching block searching with a predetermined searching range approximately the distance of the block size in X-axis and Y-axis.

13. The method of claim 12, wherein when the best matching condition is not matched, the target block of the current frame will be coded by an intra-frame coding algorithm.

14. A method of compressing and decompressing audio data stream for wireless transmission, comprising:
separating a group of audio samples into at least two sub-groups of audio samples with periodically selecting the audio samples for each sub-group;
compressing and transmitting each of the compressed sub-groups of the audio samples separately;
receiving and decoding the compressed sub-group of audio data stream separately; and
when data damage or loss happened in any audio sample within a sub-group, the interpolated value of the nearest two audio samples within another or more nearest sub-groups are used to represent the lost or damaged audio data.

15. The method of claim 14, wherein any lost or damaged audio sample of a sub-group is recovered by interpolating at least two adjacent audio samples of the nearest two sub-groups.

16. The method of claim 14, wherein the pack length of each pack of audio samples is determined by the traffic condition in the wireless transmission.

17. The method of claim 14, wherein the pack length of audio samples is reduced by half each time the audio encoder is informed about the traffic jam condition.

18. The method of claim 17, wherein the pack length of each sub-group of audio samples a minimum value which is predetermined by detecting the environment where the system is located.

19. The method of claim 17, wherein the minimum pack length of a sub-group of audio samples is longer in a location where there is less air traffic, and shorter in a location with heavier air traffic.

20. The method of claim 14, wherein the maximum pack length of a sub-group of audio samples is determined by a predetermined value and the air traffic condition of the region which the transceiver system is located.
